(19) United States
(12) Patent Application Publication
(10) Pub. No.: US 2001/0009703 A1
(43) Pub. Date: Jul. 26, 2001

(54) Blow molded article, molding machine and molding method for the blow molded article

(75) Inventor: Akira Toshikawa, Shiga (JP)

Correspondence Address: ARENT FOX KINTNER PLOTKIN & KAHN, PLLC, Suite 600, 1050 Connecticut Avenue, N.W., Washington, DC, 20036-5339, US

(73) Assignee: KABUSHIKI KAISHA TOSHIKAWA PLASTIC

(21) Appl. No.: 09/739,736

(22) Filed: Dec. 20, 2000

(30) Foreign Application Priority Data
Jan. 24, 2000 (JP) 2000-13788

(51) Int. Cl. B29D 22/00; B29C 49/00

(52) U.S. Cl. 428/35.7; 264/279.1; 264/515; 264/516; 425/113; 425/116; 425/532

(57) ABSTRACT

A blow molded article comprises a hollow body having a substantially enclosed hollow space therein, the hollow space accommodating a reinforcement for structurally reinforcing a strength of the blow molded article, with the reinforcement being tightly attached and fixed to at least a part of an internal wall defining the hollow space. A molding machine for this blow molded article comprises a pair of mold halves which can freely move to and away from each other in horizontal directions, and a parison feeder for supplying a parison downwardly between the mold halves. The parison feeder is arranged to supply a bottomless parison. Below the mold halves, the molding machine is provided with a support device which holds a reinforcement such that the reinforcement is positioned inside a hollow space in the blow molded article, and also provided with elevating means for freely raising and lowering the support device.

### BACKGROUND OF THE INVENTION

The present invention relates to a blow molded article, a molding machine and a molding method for the blow molded article.

Blow molding is a well known technology. A molten kneaded polymeric material is extruded from a double cylindrical die as a tubular polymeric melt (i.e. a parison), and the mold is closed on the parison. Compressed air is injected into the sealed parison, allowing the parison to inflate and fit the internal wall of the mold tightly. The inflated parison is cooled and solidified to give a blow molded article.

Because of the hollow structure, the blow molded article has a limited strength and is likely to suffer from warp and like deformation. Therefore, when used as a shelf board or the like, the blow molded article needs to be reinforced by a plurality of ribs arranged in the hollow space in order to keep a sufficient strength necessary for intended use.

In another method for increasing the strength, a separate reinforcing plate is attached on the external surface of a blow molded article.

Further, Japanese Utility Model Laid-open No. H4-102834 (JP-U-102834/1992) teaches to dispose a reinforcing plate in a mold during the blow molding process. The reinforcing plate is integrated at the bottom of a blow molded article.

These conventional technologies, however, have the following deficiencies.

First, in order to form a plurality of ribs, the extra ribs require an additional molding material, which inevitably extends the cooling time. These requirements raise the production cost.

Second, in attaching a separate reinforcing plate to the external surface of a blow molded article, the reinforcing plate should be provided in a post-process, which also increases the cost.

On the other hand, the third technology, which integrates a reinforcing plate at the bottom of a blow molded article, does not encounter these problems. Nevertheless, still another trouble is caused by the reinforcing plate which is exposed at the surface of a blow molded article. A metal reinforcing plate develops rust and degrades the appearance of the molded article. This is undesirable in terms of hygiene, particularly when the molded article is intended for food-related applications.

### SUMMARY OF THE INVENTION

The present invention has been worked out in view of the above problems. Its first object is to provide a blow molded article of high utility value which is refined in appearance, convenient to handle (e.g. easy to wash) and hygienic in use. The present invention also discloses a molding machine and a molding method for manufacturing such a blow molded article.

The second object is to provide a blow molded article which, even with a thin-walled body, has a high strength and prevents warp and like deformation. This blow molded article can be made of a reduced amount of molding material, for example, by decreasing the number of conventional reinforcing ribs, thus being advantageous in terms of economy and productivity. The present invention also discloses a molding machine and a molding method for manufacturing such a blow molded article.

In order to accomplish the above objects, claim 1 of the present invention provides a blow molded article manufactured by blow molding which comprises a hollow body having a substantially enclosed hollow space therein, the hollow space accommodating a reinforcement for structurally reinforcing a strength of the blow molded article, with the reinforcement being tightly attached and fixed to at least a part of an internal wall defining the hollow space.

In the blow molded article of this structure, the reinforcement lies in the hollow space in such a tightly attached manner as to form an integral structure with the blow molded article. Owing to this integration, the blow molded article is held up by the reinforcement in the hollow space and acquires an added strength. The reinforced blow molded article can retain its strength against an external force imposed thereon.

In this structure, the reinforcement may be a combined body which fits in the hollow space, wherein the reinforcement is composed of any of a plurality of linear elements, a plurality of planar elements and a combination of a linear element and a planar element (claim 2). Alternatively, the reinforcement may be a housing (claim 3).

As a molding machine for a blow molded article, claim 4 of the present invention provides a molding machine which comprises a pair of mold halves which can freely move to and away from each other in horizontal directions, and a parison feeder for supplying a parison downwardly between the mold halves. This parison feeder is arranged to supply a bottomless parison. Below the mold halves, the molding machine is provided with a support device which holds a reinforcement for structurally reinforcing a strength of the blow molded article such that the reinforcement is positioned inside a hollow space in the blow molded article, and also provided with elevating means for freely raising and lowering the support device.

The molding machine of this structure can manufacture a blow molded article which accommodates the reinforcement in the hollow space in the blow molded article, with the reinforcement being held in a vertically movable manner by the support device during the blow molding process.

Also, in this molding machine, the support device may be arranged to dispose the reinforcement at a prescribed position between the mold halves, and to move downwardly and disengage from the reinforcement at a predetermined timing while the mold halves are closed (claim 5).

With this arrangement, the reinforcement can be disposed accurately and efficiently.

Further, in this molding machine, each of the mold halves may be provided with a holder piece for holding the reinforcement just before the mold halves are closed (claim 6).

According to this modification, the reinforcement can be held by the holder pieces on the mold halves. For example, even if the reinforcement is a heavy structure, the holder pieces prevent the drop of the reinforcement after the retraction of the support device until the complete closing of the mold halves. Thus, the reinforcement can be located at a proper position.

In addition, claim 7 of the present invention provides a molding machine for a blow molded article which comprises a pair of mold halves which can freely move to and away from each other in horizontal directions, and a soften resin feeder for supplying two soften resin sheets downwardly between the mold halves. Below the mold halves, this molding machine is provided with a support device which holds a reinforcement for structurally reinforcing a strength of the blow molded article such that the reinforcement is positioned inside a hollow space in the blow molded article, and also provided with elevating means for freely raising and lowering the support device.

Also in this molding machine, the support device may be arranged to dispose the reinforcement at a prescribed position between the mold halves, and to move downwardly and disengage from the reinforcement at a predetermined timing while the mold halves are closed (claim 8).

Besides, each of the mold halves may be provided with a holder piece for holding the reinforcement just before the mold halves are closed (claim 9).

The above disclosure of the present invention is directed to the embodiments in which the mold halves open and close in horizontal directions. In addition, the present invention is applicable to the embodiments in which the mold halves open and close in vertical directions, as mentioned hereinafter.

As another different molding machine for a blow molded article, claim 10 of the present invention provides a molding machine which comprises a pair of mold halves which can freely move to and away from each other in vertical directions, and a soften resin feeder disposed at first ends of the mold halves for supplying two soften resin sheets between the mold halves. At second ends of the mold halves, this molding machine is provided with: a support device which holds a reinforcement for structurally reinforcing a strength of the blow molded article such that the reinforcement is positioned inside a hollow space in the blow molded article; drive means for driving the support device to advance and retreat freely between the mold halves; and a guide unit for guiding the soften resin sheets supplied by the soften resin feeder toward the second ends of the mold halves.

Also in this molding machine, the support device may be arranged to dispose the reinforcement at a prescribed position between the mold halves, and to retreat and disengage from the reinforcement at a predetermined timing while the mold halves are closed (claim 11).

As a molding method for a blow molding article, claim 12 of the present invention discloses a molding method comprising the following steps.

First of all, a reinforcement for structurally reinforcing a strength of the blow molded article is disposed at a prescribed position between mold halves which are open in horizontal directions. A bottomless parison is then supplied downwardly between the mold halves so as to cover the reinforcement. Further, the mold halves are closed to squeeze the bottomless parison and the reinforcement between the mold halves, and a blow molding process is continued in this state.

This molding method for a blow molded article produces a blow molded article in which the reinforcement is accommodated in the hollow space in the blow molded article.

In this method, the reinforcement may be disposed as held by the support device, and the closing of the mold halves may comprise the steps of: moving the mold halves closer to each other; temporarily stopping the mold movement when a distance between the mold halves narrows such that they can hold the reinforcement with the interposition of the bottomless parison; disengaging the support device from the reinforcement during the temporary stop; and thereafter closing the mold halves completely (claim 13).

According to claim 14 of the present invention, another molding method for a blow molded article comprises disposing a reinforcement for structurally reinforcing a strength of the blow molded article at a prescribed position between mold halves which are open, supplying two soften resin sheets between the mold halves in such a manner as to squeeze the reinforcement, closing the mold halves to squeeze therebetween the two soften resin sheets which enclose the reinforcement, and thus continuing a blow molding process.

In this method, the reinforcement may be disposed as held by the support device, and the closing of the mold halves may comprise the steps of: moving the mold halves closer to each other; temporarily stopping the mold movement when a distance between the mold halves narrows such that they can hold the reinforcement with the interposition of the two soften resin sheets; disengaging the support device from the reinforcement during the temporary stop; and thereafter closing the mold halves completely (claim 15).

### BRIEF DESCRIPTION OF THE DRAWINGS

FIG. 1 is a perspective view of the first embodiment of a blow molded article according to the present invention.

FIG. 2 is a perspective view of a reinforcement applied in the first embodiment of a blow molded article according to the present invention.

FIG. 3 is a perspective view of the second embodiment of a blow molded article according to the present invention.

FIG. 4 is a perspective view of the third embodiment of a blow molded article according to the present invention.

FIG. 5 is a perspective view of the fourth embodiment of a blow molded article according to the present invention.

FIG. 6 is a perspective view showing the structure of the first embodiment of a molding machine according to the present invention.

FIG. 7 is a side view showing the structure of the first embodiment of the molding machine shown in FIG. 6.

FIG. 8 illustrates a step of the first embodiment of a molding process according to the present invention.

FIG. 9 illustrates another step of the first embodiment of a molding process according to the present invention.

FIG. 10 illustrates still another step of the first embodiment of a molding process according to the present invention.

FIG. 11 illustrates yet another step of the first embodiment of a molding process according to the present invention.

FIG. 12 illustrates a further step of the first embodiment of a molding process according to the present invention.

FIG. 13 illustrates a still further step of the first embodiment of a molding process according to the present invention.

FIG. 14 is a perspective view of a blow molded article, just after it is manufactured in the first embodiment of a molding method according to the present invention.

FIG. 15 is a side view showing the structure of the second embodiment of a molding machine according to the present invention.

FIG. 16 is a side view showing the structure of the third embodiment of a molding machine according to the present invention.

FIGS. 17(a)-(c) illustrate steps of the third embodiment of a molding process according to the present invention.

### DESCRIPTION OF THE PREFERRED EMBODIMENTS

Embodiments of the present invention are hereinafter described with reference to the drawings.

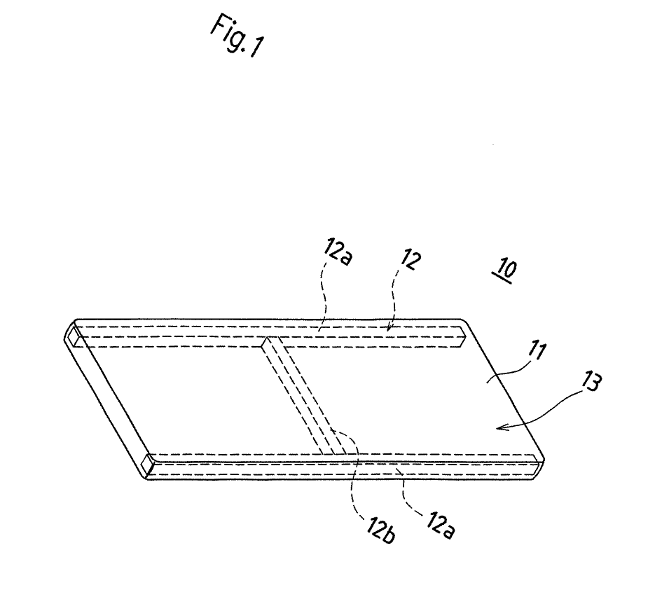

FIG. 1 is a perspective view of an embodiment of a blow molded article according to the present invention. A blow molded article (hereinafter mentioned as molded article) 10, manufactured by blow molding as mentioned later, is a hollow body made of a synthetic resin and having a hollow space 13 therein. The molded article assumes the shape of a rectangular flat plate with a certain thickness. In order to add strength to the molded article 10, a reinforcement 12 is provided in the hollow space 13 in a tightly attached and fixed manner to a molded article body 11, and thus integrated with the molded article body 11.

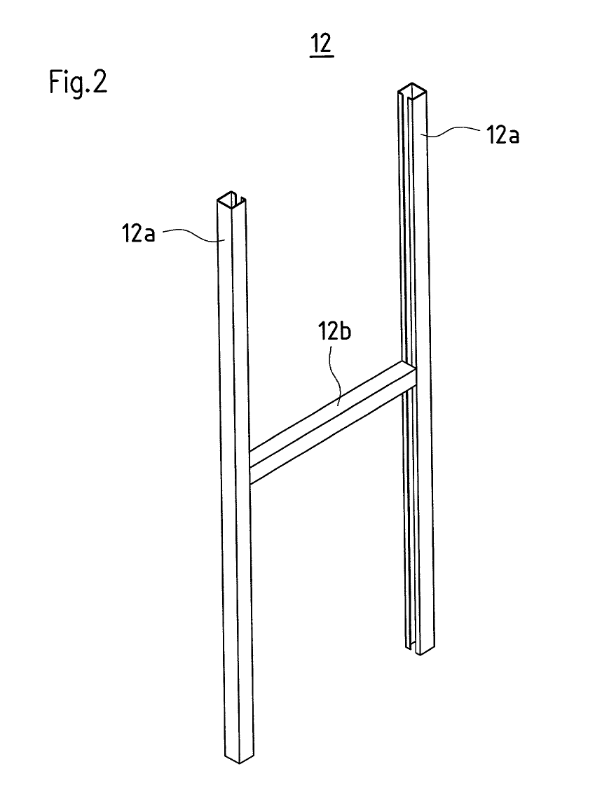

Referring to FIG. 2, the reinforcement 12 is H-shaped as a whole and comprises two vertical elements 12a and a horizontal element 12b connecting these vertical elements 12a substantially at the middle thereof. With regard to the reinforcement 12, as illustrated in FIG. 1, the vertical elements 12a extend in the longitudinal direction, while the horizontal element 12b lies approximately at the middle of the hollow space 13. The vertical elements 12a and the horizontal element 12b may be, for example, a channelled metal part.

Since the reinforcement 12 establishes an integral structure with the molded article body 11, the molded article 10 is imparted with a strength equivalent to the reinforcement 12.

In another respect, the reinforcement 12 is not exposed on the surface of the molded article body 11, which is made of a synthetic resin. This structure not only facilitates washing or other handling but also prevents development of rusts on the surface of the molded article 10. Thus, this embodiment achieves hygienic use of the molded article 10.

Strictly speaking, the solidified molded article 10 includes an air injection hole (not shown) through which air was injected at the inflation step of blow molding. Nevertheless, the hole is so small relative to the whole of the molded article 10 that the molded article 10 is regarded as a substantially enclosed hollow body.

As described above, the molded article 10 is a reinforced flat plate which is capable of retaining its strength and free from warp and like deformation. Taking this advantage, it can serve as a shelf board or the like.

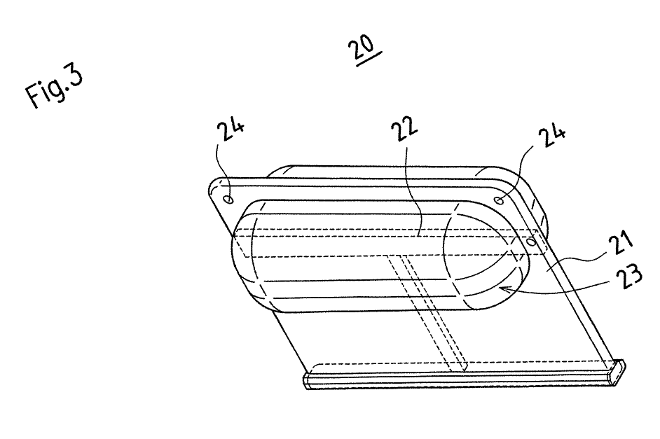

FIG. 3 shows a wave-damping barrier, as the second embodiment of a blow molded article according to the invention.

Like the first molded article 10, a molded article 20 contains a reinforcement 22 in a hollow space 23. The molded article 20 can float in the sea and absorb some wave energy. As a wave-damping barrier, the molded articles 20 are mutually connected at joint holes 24. Owing to the strength of the reinforced molded articles 20, this wave-damping barrier exhibits satisfactory durability.

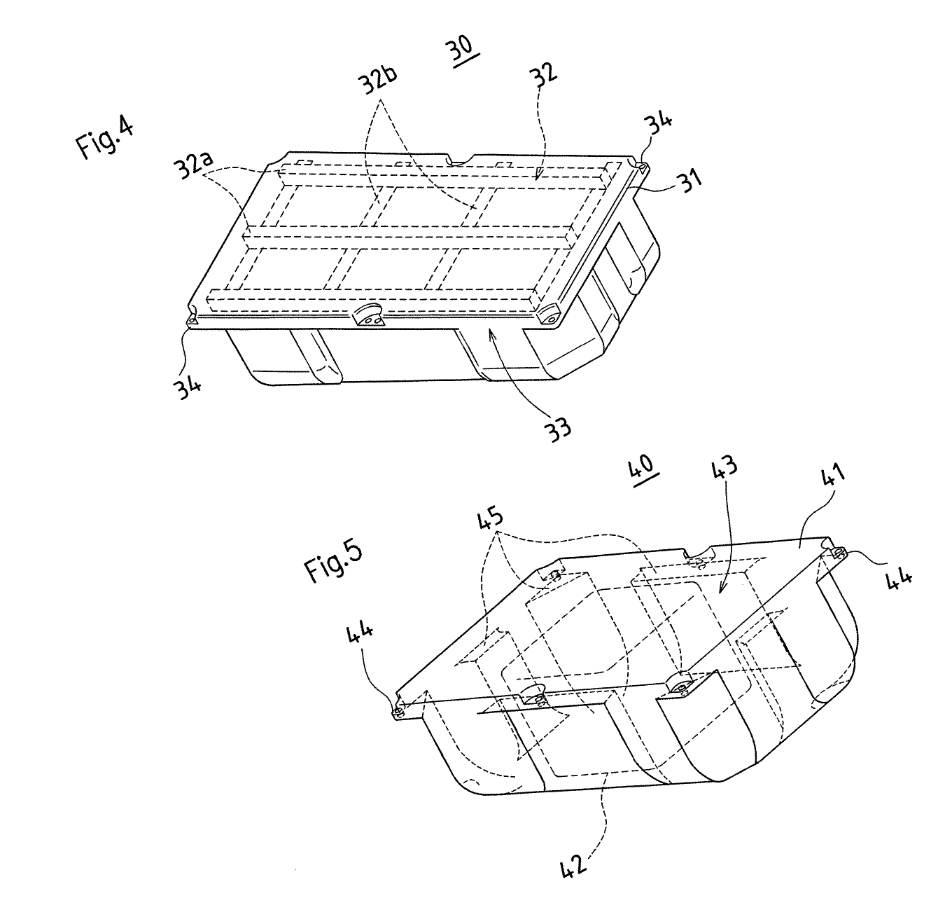

Moreover, the blow molded article of the present invention can be utilized as a scaffolding unit for reclamation work, etc. The third embodiment shown in FIG. 4 is a hollow body which can constitute a scaffolding unit. A scaffolding unit 30 comprises a body 31 and a reinforcement 32 disposed in a hollow space 33. The reinforcement 32 is composed of vertical channel-shaped metal elements 32a and horizontal plate-shaped metal elements 32b, with the respective elements being connected with each other. In the hollow space 33, three vertical elements 32a extend substantially parallel to each other in the longitudinal direction, and four horizontal elements 32b extend likewise in the lateral direction. These elements are tightly attached and fixed to the body 31. The reinforcement 32 locates near the deck of scaffolding, so as to enhance the reinforcing effect of the scaffolding unit 30.

The fourth embodiment shown in FIG. 5 provides a variation of the scaffolding unit. In a scaffolding unit 40, a hollow housing 42 constitutes the reinforcement. The housing 42 is in close contact with ribs 45 . . . 45 projecting into a hollow space 43 and fixed to a body 41. This arrangement can also provide a reinforcing effect to the scaffolding unit 40. Even if the body 41 is broken in use, the housing 42 serves as a float and secures the safety of the scaffolding unit 40.

Practically, like the molded article 20, the scaffolding units 30, 40 of the third and fourth embodiments are combined with each other at the joint holes 34, 44, respectively, and establish a desired area of scaffolding.

Regarding the use of the second to fourth embodiments, the hole formed in the blow molding process should be closed to prevent entry of sea water or the like.

The molded articles 10, 20 and the scaffolding units 30, 40 are produced with the use of molding machines and in accordance with molding methods described below.

Now, the description is turned to preferred embodiments of the molding machines and the molding methods according to the present invention.

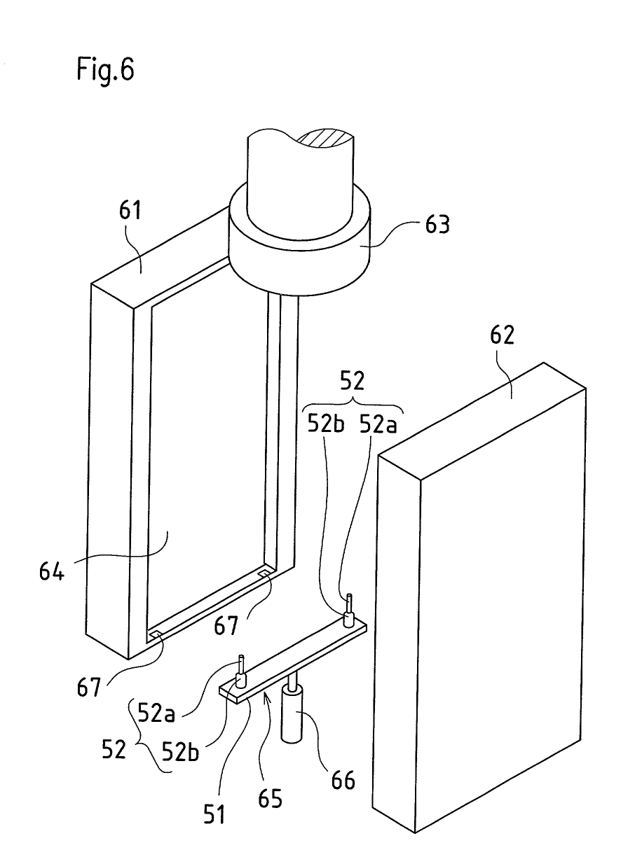

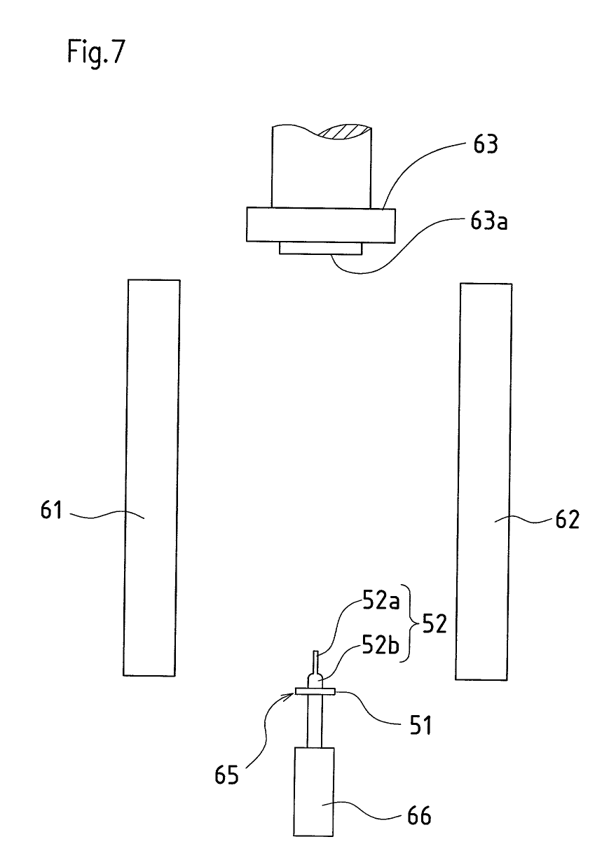

FIG. 6 is a perspective view showing the structure of the first embodiment of a molding machine according to the present invention, and FIG. 7 is a side view of the embodiment shown in FIG. 6.

The molding machine of this embodiment comprises a pair of mold halves 61, 62 (left/right mold halves in the figures) which can open and close freely, a parison feeder 63 which supplies, downwardly (from the top in the figures) between the mold halves 61, 62, a tubular so-called “bottomless parison” whose bottom end is left open (hereinafter referred to as parison), and a support device 65 disposed between the mold halves 61, 62 (at the bottom in the figures) for supporting the reinforcement 12 previously mentioned.

The mold halves 61, 62 are opened and closed freely by displacement means (not shown) using a hydraulic cylinder, etc. For the opening and closing of the mold, a parison feed point 63a (FIG. 7) in the parison feeder 63 is taken as the reference.

In the mold halves 61, 62, each of the opposing internal walls includes a cavity 64. When the mold is closed, the cavities 64 define a shape which corresponds to the molded article 10 and the reinforcement 12 integrated in the hollow space in the molded article 10.

The parison feeder 63 supplies, by means of an extruder (not shown), a parison of a molten and kneaded synthetic resin between the mold halves 61, 62. This feeder is a common device by itself.

The support device 65 comprises elevating means 66 which relies on a pneumatic or hydraulic telescopic cylinder, a base 51 provided at the top end of the extension rod of the telescopic cylinder in a vertically movable manner, and two support pins 52, 52 locating on the top surface of the base 51. Each of the support pins 52, 52 upwardly projects from the top surface of the base 51, with its tip portion 52a having a sufficient thickness to enter the bottom end of each vertical element 12a of the reinforcement 12 and its basal portion 52b being thicker than the tip portion 52a. The top end of each basal portion 52b holds the bottom end of each vertical element 12a. In other words, the support pins 52, 52 are spaced from each other in accordance with the interval between the vertical elements 12a, 12a. As a result, the reinforcement 12 is stably held on the base 51 in a standing position by inserting the tip portions 52a into the bottom ends of the vertical elements 12a and allowing the bottom ends of the vertical elements 12a to rest on the top ends of the basal portions 52b.

Owing to the up-down movement of the elevating means 66, the base 51 for mounting the reinforcement 12 ascends and descends between an upper position where the reinforcement 12 is properly positioned to the cavities 64 in the mold halves 61, 62 and a lower position to which the reinforcement descends from the upper position so that the closure of the mold halves 61, 62 is not obstructed. The vertical movement is effected on the basis of the timing for opening and closing the mold halves 61, 62 as mentioned later.

Next, the description is directed to a method for producing the molded article 10 with the use of the above molding machine.

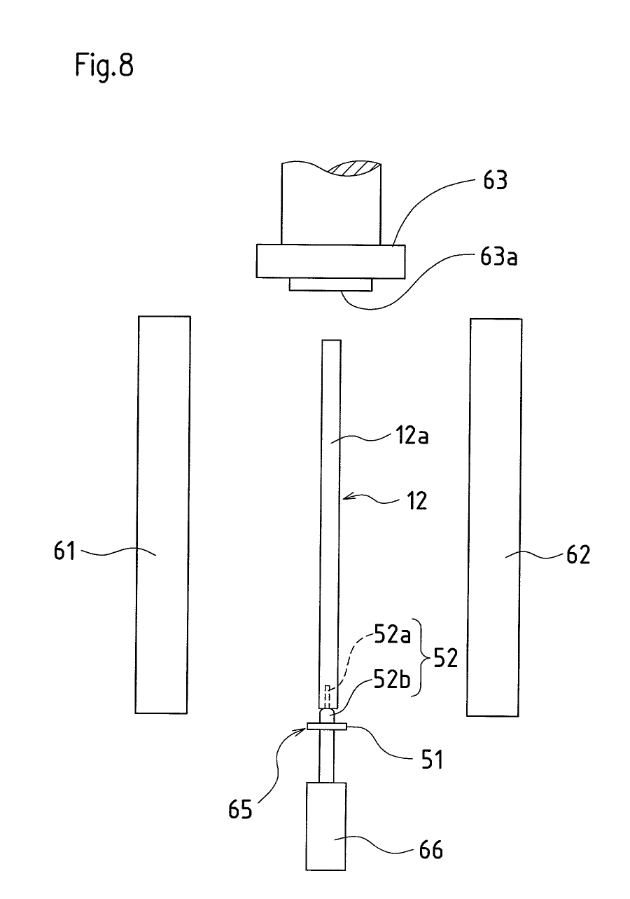

Referring to FIG. 8, while the mold halves 61, 62 are open, the base 51 is set at the upper position. The reinforcement 12 is held in a standing position on the support device 65, with the vertical elements 12a, 12a engaging with the support pins 52, 52.

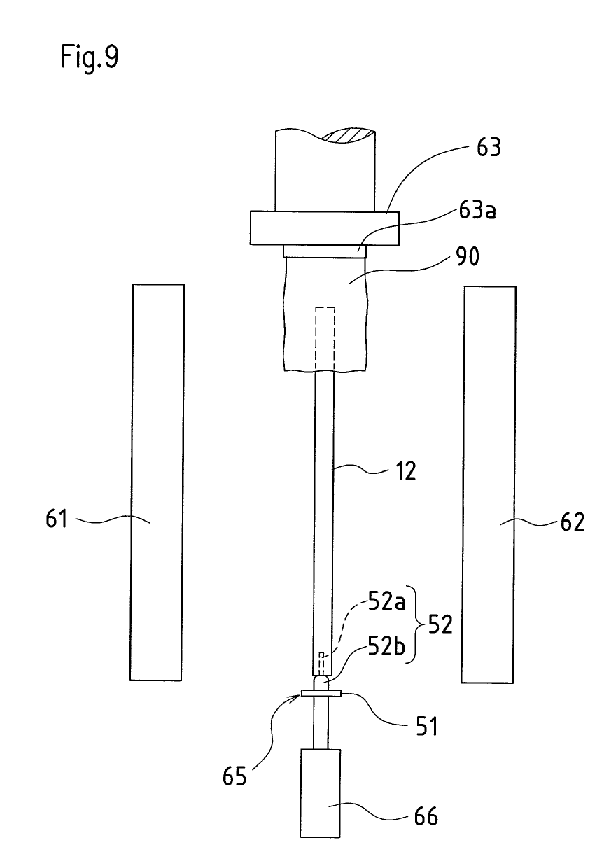

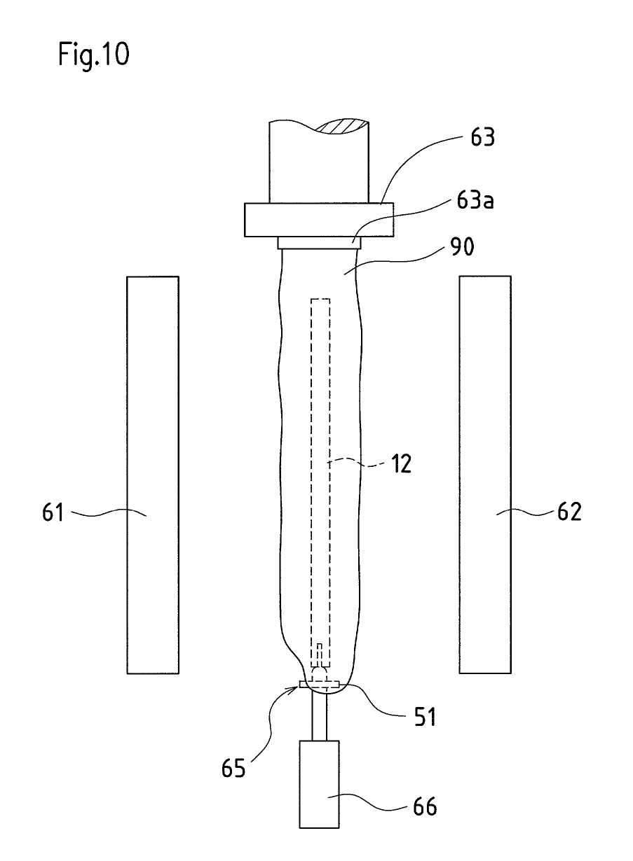

Referring next to FIG. 9, a parison 90 in the molten/kneaded state is supplied downwardly from the parison feed point 31 in a continuous manner. Through the leading end of the parison 90, the reinforcement 12 is covered by the parison 90. Then, as shown in FIG. 10, the reinforcement 12 is completely enclosed in the parison 90, whose leading end is preferably processed to form a bottom at this stage. The bottom of the parison 90 can be formed manually by an operator or mechanically by a device such as an expander. In this embodiment, it is not essential to form a complete bottom on the parison 90, and it is sufficient to provide a rough bottom.

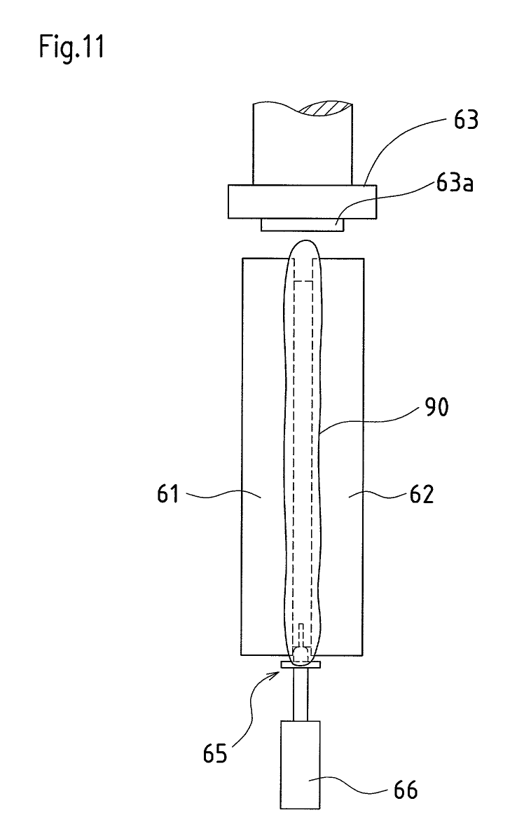

In this state, the mold halves 61, 62 are closed as shown in FIG. 11. The mold halves 61, 62 are displaced in the closing direction so as to come closer to each other, until they can hold the reinforcement 12 with the interposition of the parison 90. At this stage, the closing movement of the mold halves 61, 62 is paused for a while.

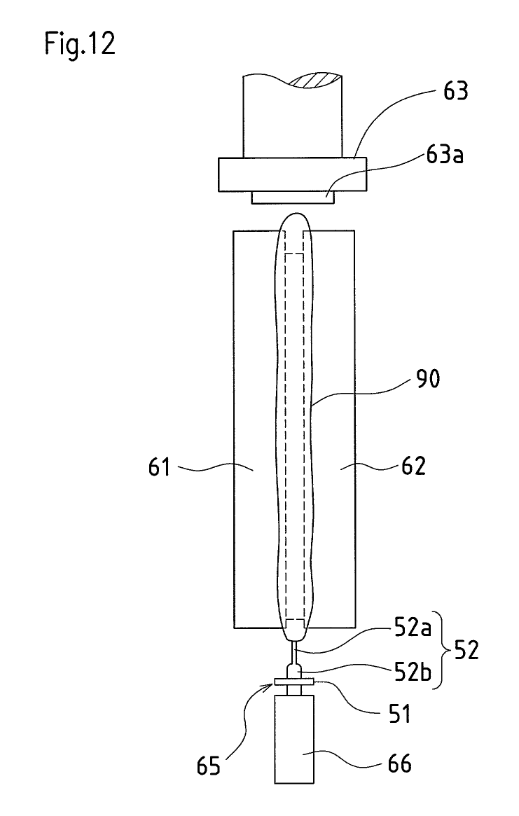

When a certain time (e.g. about 0.5 to 1.5 seconds) has passed since the temporary cessation of the closing of the mold halves 61, 62, the base 51 is brought down to the lower position by the elevating means 66, so that the support device 65 is retracted out of the reinforcement 12, as shown in FIG. 12.

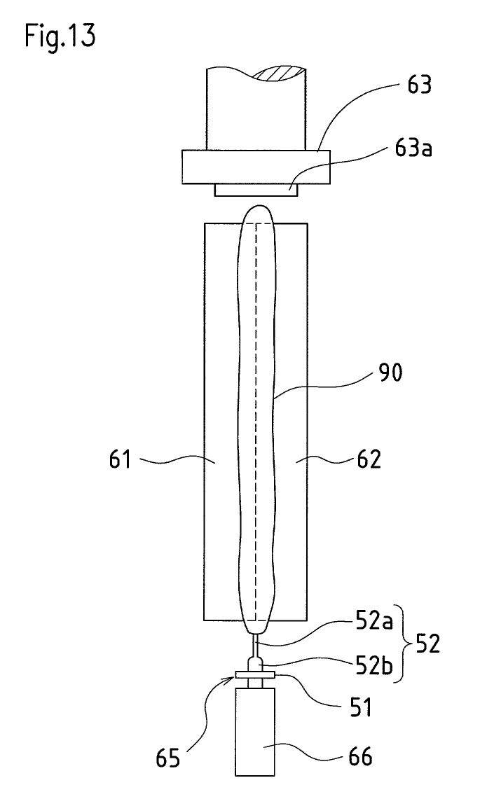

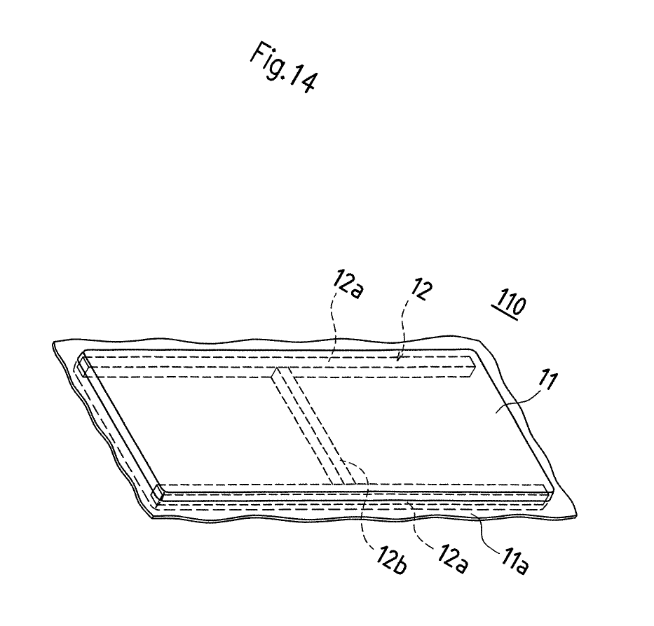

After a specified time (e.g. about 1 to 2 seconds) following the disengagement of the support device 65, the mold halves 61, 62 are displaced again in the closing direction, until they are closed tightly and completely, as shown in FIG. 13.

After the mold halves 61, 62 close on the parison 90, compressed air is injected into the parison 90 by an air supplier (not shown) from the side of the mold 61 or the mold 62, whereby the parison 90 is forced to inflate against the cavities 64 in the mold halves 61, 62. The thus inflated parison 90 is left for a specified time for cooling and solidification. Finally, the molded article 10 internally integrated with the reinforcement 12 is obtained by opening the mold halves 61, 62 and removing the molded product therefrom.

As shown in FIG. 14, immediately after the mold removal, the molded article 110 has a flash 11a formed around the body 11. The flash 11a is composed of a parison which has run off from the periphery of the mold halves 61, 62 and which has been solidified by cooling together with the parison 90 enclosed in the mold halves 61, 62. To give the final molded article 10 as shown in FIG. 1, the flash 11a should be cut off along the periphery of the body 11.

In the above description, the time parameters are given merely for the purpose of illustration (e.g. the timing of retracting the support device 65 to the lower position after the closing of the mold halves 61, 62 is stopped temporarily; the timing of resuming the closure of the mold halves 61, 62 for complete closure after the support device 65 is dislocated to the lower position). These time parameters can be optionally set in accordance with the size, weight and shape of the molded article 10 and the reinforcement 12.

The closing movement of the mold halves 61, 62 and the up-down movement of the support device 65 are controlled by a control unit (not shown) provided in the molding machine. With continual inputs of operation command data for desirable movements, these devices can operate at the best timing for the manufacture of the molded article 10.

Because the reinforcement 12 provided in the molded article 10 increases the strength of the molded article 10, the resulting molded article 10 can be composed of the body 11 having thin walls, without suffering from warp and like deformation. Moreover, since conventional reinforcing ribs are no longer necessary, this structure shows economic advantage by reducing the amount of material for the molded article 10 and enhances the productivity by cutting the cooling time accordingly.

Additionally, in the above-described manufacture of the molded article 10, when the mold halves 61, 62 are closed, the reinforcement 12 lies between the mold halves 61, 62 as enclosed in the parison 90. In other words, the reinforcement 12 remains to be held by the viscosity, etc. of the parison, after the support device 65 is retracted to the lower position. As a result, even if the reinforcement 12 has no support by the mold halves 61, 62 and the support device 65 is nevertheless retracted to the lower position, the reinforcement 12 can be supported without problem in a comparatively stable manner.

Still, if the reinforcement 12 is too heavy, it may downwardly slip out of the proper position between the mold halves 61, 62, after the support device 65 is retracted to the lower position and before the mold halves 61, 62 are completely closed.

In order to prevent this accident, the mold halves 61, 62 are provided with holder pieces, so that the mold halves 61, 62 can compulsorily hold a portion of the reinforcement 12 when the mold halves 61, 62 are closed and temporarily stopped with a predetermined distance between each other. To be specific, referring to FIG. 6, the holder pieces 67 locate along the bottom edge of the cavities 64 in the mold halves 61, 62. During the temporary halt of the mold halves 61, 62, the holder pieces 67 can catch and hold a portion of the bottom edge of the reinforcement 12, thereby preventing dislocation of the reinforcement 12 and keeping it properly positioned.

In addition to the use as a shelf board and the like as described in the above embodiments, the molded articles according to the present invention are extensively applicable in any other fields. In contrast, prior art blow molded articles have a limited range of application, because their hollow structure shows a poor strength and vulnerability to deformation. In this respect, the present embodiments have solved one of the conventional deficiencies.

Likewise, the shape and material of the reinforcement 12 should not be limited by the above embodiments. The reinforcement 12 can be made of any material and in any shape, depending on the shape and required strength of the molded article. For example, the reinforcement 12 may be formed of a synthetic resin by injection molding or the like, or made of aluminum. For an added value, the reinforcement 12 can be made of a magnetic material, in which case a blow molded article with a synthetic resin surface gains a magnetic function and expands its applicability.

For the movement of the base 51, the elevating means 66 may apply a rack-and-pinion mechanism or a ball screw-rotation mechanism. When these mechanisms are operated by a servomotor, the reinforcement 12 can be positioned relative to the mold halves 61, 62 with high accuracy. In the first embodiment of the subject molding machine, the support pins 52 are directly involved in the support of the reinforcement 12. Instead of the support pins 52, such support means may be a chuck or the like which grips the bottom end of the reinforcement 12. The support means only needs to be capable of stably holding the reinforcement 12 and smoothly disengageable therefrom, and can be selected in accordance with the shape, etc. of the reinforcement 12.

Besides, the reinforcement 12 may be mechanically placed onto the support device 65 by a suitable supply device. Likewise, the molded article 10 may be mechanically removed from the mold by a removal device. These arrangements enable automatic manufacture of the molded article 10 and enhance the productivity.

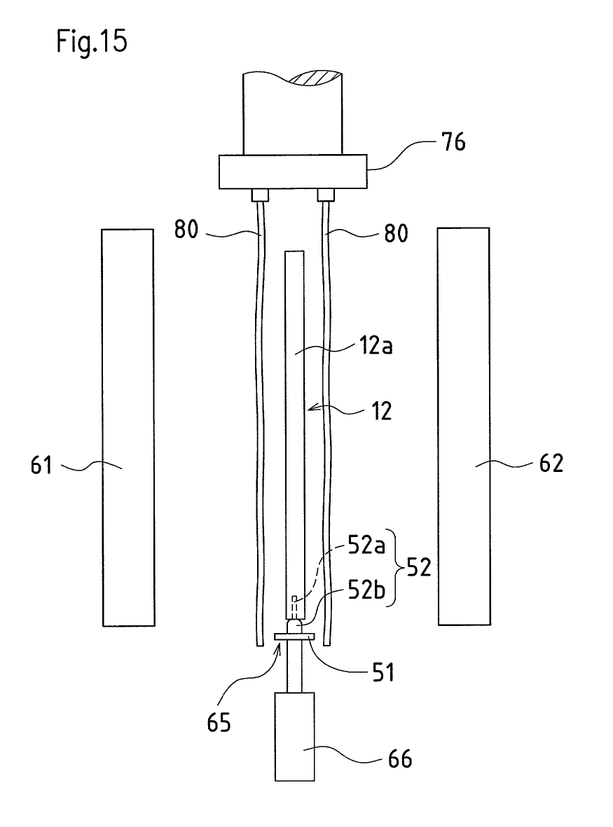

FIG. 15 is a side view showing the structure of the second embodiment of a molding machine according to the present invention. The same or equivalent elements of the molding machine in FIGS. 6 and 7 are herein mentioned by the same reference numbers and not described specifically.

The second molding machine comprises the mold halves 61, 62 and a soften resin feeder 76 disposed above the mold halves 61, 62 for supplying heat-soften resin sheets 80 on the left and right sides (as illustrated) of the reinforcement 12. Except for the shape, the soften resin sheets 80 fed by the soften resin feeder 76 have the same properties, etc. as the bottomless parison supplied by the parison feeder 63.

With the use of the second molding machine, a blow molded article which internally comprises a reinforcement is manufactured in the following manner (second embodiment of the molding method). Two heat-soften resin sheets 80 are supplied downwardly by the soften resin feeder 76 such that the reinforcement 12 locates therebetween in a sandwiched manner. By closing the mold halves 61, 62, the reinforcement 12 is enclosed in the two soften resin sheets 80 which are squeezed between the mold halves 61, 62. Thereafter, as in the former method, blow molding is carried out to give the molded article 10. The closing movement of the mold halves 61, 62 and the movement of the support device 65 in connection with the closing movement proceed in the same manner as above.

The molding machines and molding methods in the above descriptions are directed to the embodiments in which the mold halves 61, 62 open and close in the left/right directions (i.e. horizontal directions). Further, they are applicable to an operation in which the mold halves 61, 62 open and close in the upward/downward directions (i.e. vertical directions). The molding machine and the molding method based on the up-down mold movement are hereinafter described as the third embodiment.

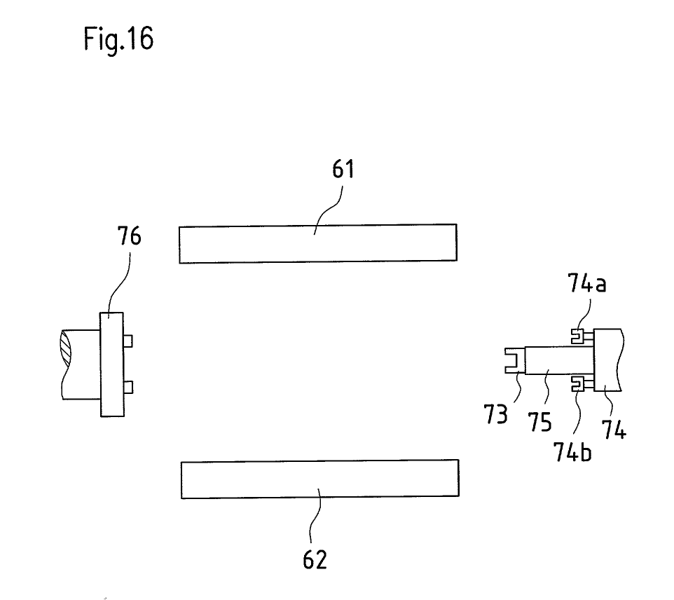

Referring to FIG. 16, the molding machine of the third embodiment has a guide unit 74 for allowing the soften resin feeder 76 to supply the soften resin sheets 80 above and below the reinforcement 12 at the same time. The guide unit 74 comprises chucks 74a, 74b which can advance and retreat freely and a controller (not shown) for controlling the drives of the advance/retreat and grip actions of the chucks 74a, 74b. The soften resin sheets 80 are transferred to prescribed positions at a speed nearly equivalent to the soften resin feed rate, with the resin sheets 80 being gripped by the chucks 74a, 74b and kept at specified heights so as not to sag downwardly by the gravity. The controller controls the drive of a series of actions of the guide unit 74. The third embodiment utilizes a support device 73 and displacing means 75 for advancing and retracting the support device 73, as respective equivalents for the support device 65 for supporting the reinforcement 12 and the elevating means 66 as mentioned in the first embodiment (FIG. 6) and the second embodiment (FIG. 15). Like the preceding embodiments, the closing movement of the mold halves 61, 62 and the advance/retreat movement of the support device 73 are controlled by a control unit (not shown) in the molding machine.

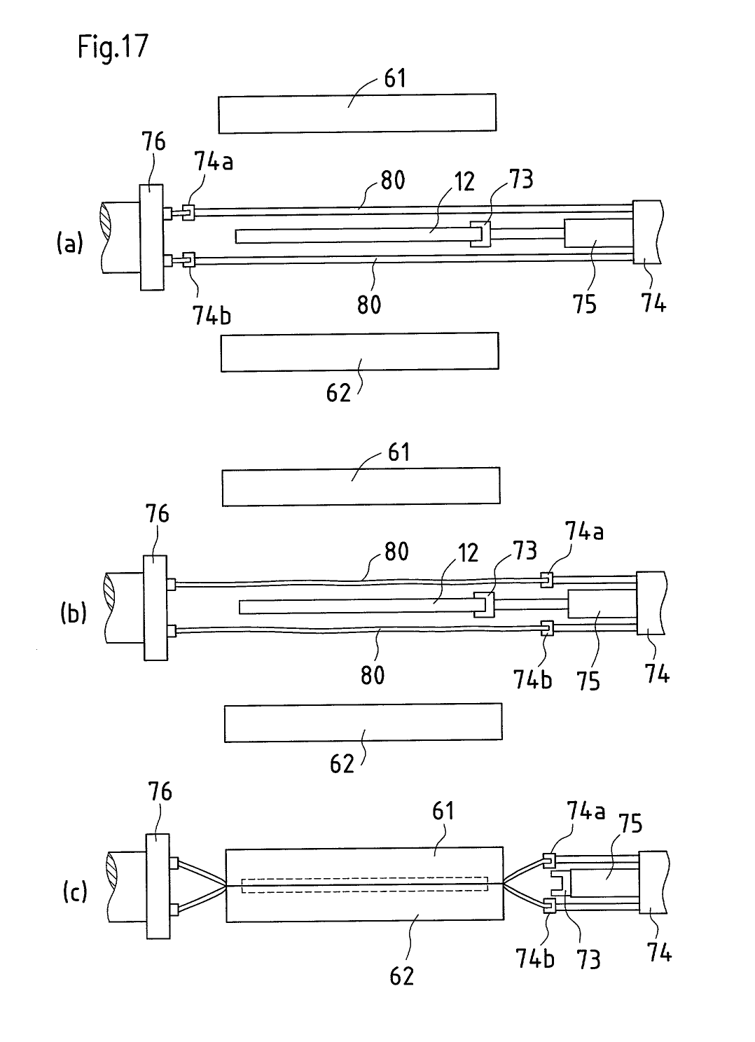

Referring now to FIG. 17, the description is turned to the molding method using the third molding machine (third embodiment of the molding method).

As shown in FIG. 17(a), while the mold halves 61, 62 are open, the reinforcement 12 is held substantially horizontal by the support device 73. With the start of the supply of two soften resin sheets 80 from the soften resin feeder 76, the drive of the guide unit 74 is activated at the same time. The chucks 74a, 74b move toward the soften resin feeder 76 and grip the tips of the coming soften resin sheets 80. Then, as shown in FIG. 17(b), the chucks 74a, 74b move to the prescribed positions, with gripping the tips of the soften resin sheets 80 such that they are kept at specified heights and do not sag down by the gravity. The moving speed of the chucks 74a, 74b is nearly equivalent to the feed rate of the soften resin sheets 80. In this way, the soften resin sheets 80 are supplied above and below the reinforcement 12. As the next step, the mold halves 61, 62 are brought closer to each other and stopped temporarily at predetermined positions. During this stop, the support device 73 is disengaged out of the reinforcement 12 and retreated from the mold halves 61, 62. After the retreat of the support device 73, the mold halves 61, 62 are closed completely as illustrated in FIG. 17(c), with the two soften resin sheets 80 sandwiching and enclosing the reinforcement 12. Subsequent blow molding gives a desired blow molded article.

What is claimed is:

1. A blow molded article manufactured by blow molding, which comprises a hollow body having a substantially enclosed hollow space therein, the hollow space accommodating a reinforcement for structurally reinforcing a strength of the blow molded article, with the reinforcement being tightly attached and fixed to at least a part of an internal wall defining the hollow space.

2. A blow molded article according to claim 1, wherein the reinforcement is a combined body which fits in the hollow space and wherein the reinforcement is composed of any of a plurality of linear elements, a plurality of planar elements and a combination of a linear element and a planar element.

3. A blow molded article according to claim 1, wherein the reinforcement is a housing.

4. A molding machine for a blow molded article comprising a pair of mold halves which can freely move to and away from each other in horizontal directions, and a parison feeder for supplying a parison downwardly between the mold halves,
wherein the parison feeder is arranged to supply a bottomless parison,
wherein, below the mold halves, the molding machine is provided with a support device which holds a reinforcement for structurally reinforcing a strength of the blow molded article such that the reinforcement is positioned inside a hollow space in the blow molded article, and also provided with elevating means for freely raising and lowering the support device.

5. A molding machine for a blow molded article according to claim 4, wherein the support device is arranged to dispose the reinforcement at a prescribed position between the mold halves, and to move downwardly and disengage from the reinforcement at a predetermined timing while the mold halves are closed.

6. A molding machine for a blow molded article according to claim 4 or 5, wherein each of the mold halves is provided with a holder piece for holding the reinforcement just before the mold halves are closed.

7. A molding machine for a blow molded article comprising a pair of mold halves which can freely move to and away from each other in horizontal directions, and a soften resin feeder for supplying two soften resin sheets downwardly between the mold halves,
wherein, below the mold halves, the molding machine is provided with a support device which holds a reinforcement for structurally reinforcing a strength of the blow molded article such that the reinforcement is positioned inside a hollow space in the blow molded article, and also provided with elevating means for freely raising and lowering the support device.

8. A molding machine for a blow molded article according to claim 7, wherein the support device is arranged to dispose the reinforcement at a prescribed position between the mold halves, and to move downwardly and disengage from the reinforcement at a predetermined timing while the mold halves are closed.

9. A molding machine for a blow molded article according to claim 7 or 8, wherein each of the mold halves is provided with a holder piece for holding the reinforcement just before the mold halves are closed.

10. A molding machine for a blow molded article comprising a pair of mold halves which can freely move to and away from each other in vertical directions, and a soften resin feeder disposed at first ends of the mold halves for supplying two soften resin sheets between the mold halves,
wherein, at second ends of the mold halves, the molding machine is provided with: a support device which holds a reinforcement for structurally reinforcing a strength of the blow molded article such that the reinforcement is positioned inside a hollow space in the blow molded article; drive means for driving the support device to advance and retreat freely between the mold halves; and a guide unit for guiding the soften resin sheets supplied by the soften resin feeder toward the second ends of the mold halves.

11. A molding machine for a blow molded article according to claim 10, wherein the support device is arranged to dispose the reinforcement at a prescribed position between the mold halves, and to retreat and disengage from the reinforcement at a predetermined timing while the mold halves are closed.

12. A molding method for a blow molded article which comprises disposing a reinforcement for structurally reinforcing a strength of the blow molded article at a prescribed position between mold halves which are open in horizontal directions, supplying a bottomless parison downwardly between the mold halves to cover the reinforcement, closing the mold halves to squeeze the bottomless parison and the reinforcement between the mold halves, and thereafter continuing a blow molding process.

13. A molding method for a blow molded article according to claim 12,
wherein the reinforcement is disposed as held by the support device,
wherein the closing of the mold halves comprises the steps of: moving the mold halves closer to each other; temporarily stopping the mold movement when a distance between the mold halves narrows such that they can hold the reinforcement with the interposition of the bottomless parison; disengaging the support device from the reinforcement during the temporary stop; and thereafter closing the mold halves completely.

14. A molding method for a blow molded article which comprises disposing a reinforcement for structurally reinforcing a strength of the blow molded article at a prescribed position between mold halves which are open, supplying two soften resin sheets between the mold halves in such a manner as to sandwich the reinforcement, closing the mold halves to squeeze therebetween the two soften resin sheets which enclose the reinforcement, and thereafter continuing a blow molding process.

15. A molding method for a blow molded article according to claim 14,
wherein the reinforcement is disposed as held by the support device,
wherein the closing of the mold halves comprises the steps of: moving the mold halves closer to each other; temporarily stopping the mold movement when a distance between the mold halves narrows such that they can hold the reinforcement with the interposition of the two soften resin sheets; disengaging the support device from the reinforcement during the temporary stop; and thereafter closing the mold halves completely.
